(19) United States
(12) Patent Application Publication
(10) Pub. No.: US 2026/0170342 A1
(43) Pub. Date: Jun. 18, 2026

(54) TRAINING NEURAL NETWORKS FOR MULTI-CORE DATA PROCESSING

(71) Applicant: Snap Inc., Santa Monica, CA (US)

(72) Inventors: Orlando Miguel Pires dos Reis Moreira, Eindhoven (NL); Luc Johannes Wilhelmus Waeijen, Haelen (NL); Zeqi Zhu, Eindhoven (NL); Savvas Sioutas, Eindhoven (NL); Arash Pourtaherian, Waalre (NL)

(21) Appl. No.: 19/129,227

(22) PCT Filed: Nov. 13, 2023
(86) PCT No.: PCT/EP2023/081658

§ 371 Date: May 12, 2025

(30) Foreign Application Priority Data
Nov. 14, 2022 (EP) 2290061.5

(51) Int. Cl. G06N 3/084

(52) U.S. Cl. CPC G06N 3/084

(57) ABSTRACT

The present disclosure provides a method and system for training a neural network to be executed by a processor system comprising a plurality of processor cores. During training, an aggregate loss is computed that is based on a task loss indicative of an accuracy with which the neural network performs a task and based on a computation performance loss which indicates an estimation of a computation performance parameter. Weights of the neural network are then updated by backpropagation of the aggregated loss.

### BACKGROUND

The present disclosure pertains to a method for training a neural network for a multi-core data processing system.

The present disclosure further pertains to a system for training a neural network for a multi-core data processing system.

In the last few decennia, more and more powerful neural networks have been developed and been applied to more and more applications like image processing, data analysis, device control and the like. Neural networks comprise a plurality of neural network elements that are interlinked to other neural network elements through interconnections having respective weights. The weights are determined in a training stage using training data pairs. Each training data pair comprises respective input data to be provided at an input of the neural network to be trained and respective ground truth output data for comparison with the output data computed by the neural network. A loss is computed that is indicative for a difference between the output data computed by the neural network and the ground truth output data. Although the neural network elements of the neural network may be potentially linked in any possible manner, the neural network is typically organized in neural network layers. Whereas a neural network could in principle be executed by a single data processor, this would in generally involve a too low throughput and a too high latency for practical purposes. Accordingly, it is necessary to map the neural network on a multi-core processor. This implies that the computational load and the storage requirements involved in the neural network operations are assigned in a distributed manner to the processor cores of the multi-core processor. As one example, in a neural network having a plurality of layers, each of the layers may be assigned a respective number of processor cores with respective processing capacity and a respective storage space, so that the respective processor cores performs all computations for the neural elements in the layer and the storage space is used to store the feature map of the layer. In practice the mapping with which the resources of a multi-core processor can be exploited optimally is strongly dependent on the number of available cores and the nature of the layers.

Balancing the load can in theory be achieved by allocating more compute power to compute-heavy layers and less compute power to the other layers. In this connection it is noted that Shen discusses a global resource allocation optimization problem, aiming at maximizing the accuracy while constraining latency under a predefined budget in: “HALP: hardware-aware latency pruning” arXiv: 2110.10811v1 [cs.CV] 20 Oct. 2021. The method disclosed therein comprises calculation of a lookup table (one time) for estimating the latency of each layer based on static properties of the layer, i.e. number of input and output channels. However, in practice the possibilities for resource allocation are restricted by specific resource and routing constraints. I.e. the mapping of the neural network also involves an allocation of communication channels, e.g. using a network on chip (NoC) in the multi-core processor. In particular in a sparse neural network the computational load distribution is strongly dependent on the weights assigned to the neural network interconnections during training of a neural network for a specific purpose.

### SUMMARY

It is a first object of the present disclosure to provide an improved method for training a neural network that aims to optimize the neural network for execution on a multi-core data processing system taking into account specific resource and routing constraints.

It is a second object of the present disclosure to provide an improved training system for training a neural network that aims to optimize the neural network for execution on a multi-core data processing system taking into account specific resource and routing constraints.

In accordance with the first object, an improved method is provided herewith for training a neural network to perform a data processing task when executed by a processor system comprising a plurality of processor cores. A particular multi-core processor system for which the neural network is trained to perform the data processing task is further also denoted as target processor system. In one example the target processor system is incorporated in a mobile phone. In another example the target processor system is provided by a GPU on a laptop.

The improved method for training comprises providing a neural network architecture for the neural network. The neural network architecture specifies the components of the network, e.g. convolutional layers, pooling layers and their interrelationship. The network architecture can be one known as such, e.g. a version of ResNet, of MobileNet or VGG or otherwise. The network as provided herewith may be pre-trained or may not be trained at all yet. Anyhow it is presumed that it is not yet (optimally) suitable to perform the data processing task on the target processor system. Accordingly the improved method comprises that training data is obtained with which the neural network will be trained to perform the data processing task. The training data comprises input data and ground truth output data.

The improved method provides a mapping of the neural network on the multicore processor system. The mapping determines in particular an allocation of cores of the multicore processor system to layers of the neural network. This mapping can be provided by a conventional mapping method. An example thereof is described by Dai et al. in “ChamNet: Towards Efficient Network Design through Platform-Aware Model Adaptation”, arXiv: 1812.08934v1 [cs.CV] 21 Dec. 2018.

Then the following sequence of training steps is repeated. Repetition can be a predetermined number of times or can be stopped upon detection of a convergence criterion.

In a first training step in the sequence a specimen of input data of the training data is provided to a training processor system that executes the neural network being trained. In this connection it is noted that the training processor system is not necessarily the target processor. Typically the training processor system has a higher processing capacity than that of the target processor system.

In the next training step in the sequence the training processor system executes the neural network being trained to generate output data in response to the input data.

Ground truth data corresponding to the specimen of input data is provided and a task loss is computed that is indicative for a deviation between the generated output data and the ground truth output data. The task loss is for example a cross-entropy loss for classification, an L1-norm for regression or a combination thereof.

In addition a computation performance loss is computed that is indicative for a cost of executing the neural network as if it were executed by the target processor system in accordance with the provided mapping. The computation performance loss is for example a measure for latency, e.g. per layer or an overall latency, a throughput, a required supply power or a combination thereof. The computation performance loss can for example be proportional to the latency, but alternatively it can be proportional to a first difference between the latency and an theoretically achievable minimum value for the latency. As an other example, the computation performance loss can be reversely proportional to the throughput, but alternatively it can be proportional to a second difference between the inverse value of the throughput and an theoretically achievable minimum value for this measure. As a further example, the computation performance loss can be proportional to the power consumption, but alternatively it can be proportional to a third difference between the power consumption and an theoretically achievable minimum value for the power consumption. In a still further example the computation performance loss is a weighted sum of two or more of the first difference, the second difference and the third difference. In particular the overall latency and the overall throughput are very important computation performance indicators.

Then an aggregate loss is computed that is positively correlated with both the task loss and the computation performance loss. As an example the aggregate loss is computed as a weighted sum of the task loss and the computation performance loss. However other implementations of the loss weighting unit LWU are also possible, provided that the operation it performs is differentiable.

In a subsequent operation of the sequence, weights of the neural network being trained are updated by backpropagation of the aggregated loss.

Due to the fact that the aggregated loss is partly determined by the latency loss, the backpropagation not only results in an adaptation of the network parameters that contribute to an improved accuracy but also results in a reduction of the computation loss for example by a reduction of latency that is expected for the neural network being trained when mapped on the target hardware. Hence, contrary to the method disclosed by Shen et al, wherein a fixed compute cost per groups of feature maps for the target hardware is presumed, the improved method computes the cost of each group of neurons depending on the mapping of the network to the multi-core architecture, which is changing as weight sparsity and precision are changing throughout the training procedure.

In one embodiment the originally created mapping is used to actually map the trained neural network on the target processor system. Even in case this original mapping is not optimal, the improved training method still contributes to a low computation performance loss, in that it tends to train the neural network such that a computational load occurring in the neural network layers that dominate the overall computation performance loss of the neural network is reduced. In an example, the sequence of training steps specified above is repeated a predetermined number of times. In another example the sequence of training steps is repeated until a convergence criterion is complied with. This is for example the case if the aggregate loss achieves a value less than a specified threshold value.

In this connection it is noted that also activation sparsity plays a role in that depending on the selected weights, neural network layers can have a lower or a higher output activity. This in turn affects the required from the subsequent neural network layers.

In some embodiments the method comprises executing a neural network remapping step each time after a predetermined number of training sequences has been performed. In the neural network remapping step the currently provided mapping and weight distribution is replaced with a different mapping and weight distribution taking into account the computational load associated with the activation sparsity occurring in the neural network layers identified during the predetermined number of training sequences. The role of the weight distribution is twofold. In the first place increasing the number of 0 weights affects mapping not only by reducing the computational load but also by reducing requirements of memory resources. In the second place, weight adjustment may lead to a different activation rate for neurons. Subsequent to remapping and renewed distribution of weights the training sequence is again performed a predetermined number of times to minimize the aggregate loss of the neural network in accordance with the new mapping.

In these or other embodiments the method for training may further comprise pruning the neural network each time after a predetermined number of training sequences has been performed.

In these or other embodiments the method for training may further comprise adapting a number of quantization levels of neural network computations each time after a predetermined number of training sequences has been performed.

In these or other embodiments the method for training further comprises adapting an activation sparsity each time after a predetermined number of training sequences has been performed.

In an embodiment the computation performance loss is determined on the basis of the amount of non-zero values in a layer's input and its kernel size. Therewith computation performance parameters, such as a latency per layer per core can be estimated. This information can further be used to steer one or more of pruning, quantization, activation regularization, gating or dropout to be more aggressive on the layers with higher latency per core, by means of adjusting their coefficients per layer. Contrary to known approaches these optimizations are performed as part of a mapping aware training procedure. Therewith it is achieved that the optimizations indeed contribute to the neural network as mapped on the target hardware.

According to one approach, which is applicable if computation performance information, such as throughput information, power consumption information and/or latency information of individual layers is absent, a training method such as evolutionary training, reinforcement learning, Bayesian optimization, etc, can be used as a learning, heuristic search strategy to find the set of weights that give the lowest computation performance loss. In this approach weights of the neural network element are randomly mutated and the “computation performance loss space” is evaluated. Then, the weight sets with the least amount of computation performance loss are again selected for reproduction. The cycle begins again as the loss of the weight sets is evaluated and the least fit sets are eliminated. Similarly, other methods, such as reinforcement learning and Bayesian optimization are applicable if latency information of individual layers is absent.

In an embodiment, the computation performance loss is then computed as the accumulation of latency per core for all the layers by

$${L}_{P} = {\sum }_{l} \frac{{Kx}_{l} \cdot {Ky}_{l} \cdot {Kz}_{l} \cdot {‖ {X}_{l} ‖}_{n}}{{C}_{l}} ,$$

in which Kxₗ, Kyₗ, Kzₗ are the kernel size in x, y, and z dimensions, respectively for layer l, Cₗ is the number of cores allocated to layer l and wherein

$${‖ X ‖}_{n} = \sqrt[n]{\sum {\vert x \vert}^{n}} ,$$

is an indicator for the ratio of non-zero weights in the kernel, where n is a hyperparameter.

The computation performance loss is aggregated with the task loss in the back propagation phase allowing for the weight updates in the direction of the least computation performance loss and least task loss. Similarly, the mapping algorithm can be re-evaluated after n training steps, to update the Cₗ and ensures its validity.

In the case that the loss function is differentiable with respect to the output/weights, the gradient of the loss can be calculated with respect to the weights of the last layer, and consequently with respect to the weights of previous layers using the chain rule. Then the weights are changed by the negative of the gradient, which is the direction of the minimum aggregate loss value [Goodfellow, Ian; Bengio, Yoshua; Courville, Aaron (2016). “6.5 BackPropagation and Other Differentiation Algorithms”. Deep Learning. MIT Press. pp. 200-220. ISBN 9780262035613]. The improved method as disclosed herein identifies compute-heavy layers and bottlenecks by continuously mapping each layer to different cores of the massive-multicore system and enforces sparsity in these identified elements of the processing chain. Therewith the improved method results in a mapped neural network with a reduced computation performance loss, for example a reduced inference latency and an enhanced throughput as compared to with what can be achieved with the global optimization techniques discussed above. Furthermore, contrary to prior art approaches, the improved method maximizes resource utilization in a multi-core system.

In accordance with the second object, an improved training system is provided for training a neural network. The improved training system is configured to train the neural network to perform a data processing task when executed by a multicore processor system comprising a plurality of processor cores.

The training system is further configured to receive a specification of a neural network architecture for the neural network, as well as training data for determining neural network parameter values by training the neural network.

The training data comprises a plurality of pairs of input data and associated ground truth output data.

The training system is configured to provide a mapping of the neural network for the multicore processor system and to execute the neural network for training. To that end, the training system is configured to repeat a training sequence that comprises operations wherein the weights of the neural network are updated by backpropagation of an aggregate loss computed in the course of executing the neural network by the training system using the training data. More specifically therewith the training system executes the neural network being trained to generate output data therewith in response to a sample of the input data. The training system computes a task loss that is indicative for a deviation between the generated output data and the ground truth output data corresponding to that sample of the input data. The training system computes a computation performance loss that is indicative for a cost of executing the neural network as if it were executed by the multi-core processor system in accordance with the provided mapping. Subsequently, the training system computes an aggregate loss that is positively correlated with both the task loss and the computation performance loss. The training system then updates weights of the neural network that is being trained by backpropagation of the aggregated loss.

### BRIEF DESCRIPTION OF THE DRAWINGS

These and other aspects of the invention are described in more detail with reference to the drawings. Therein

FIG. 1 schematically shows a first embodiment of the improved training method;

FIG. 2 schematically shows a second embodiment of the improved training method;

FIG. 3 schematically shows a first embodiment of an improved training system;

FIG. 4 schematically shows an aspect of a second embodiment of an improved training system;

FIG. 5 schematically shows an aspect of a third embodiment of an improved training system.

### DETAILED DESCRIPTION OF EMBODIMENTS

In the description like reference symbols in the various drawings indicate like elements unless otherwise indicated.

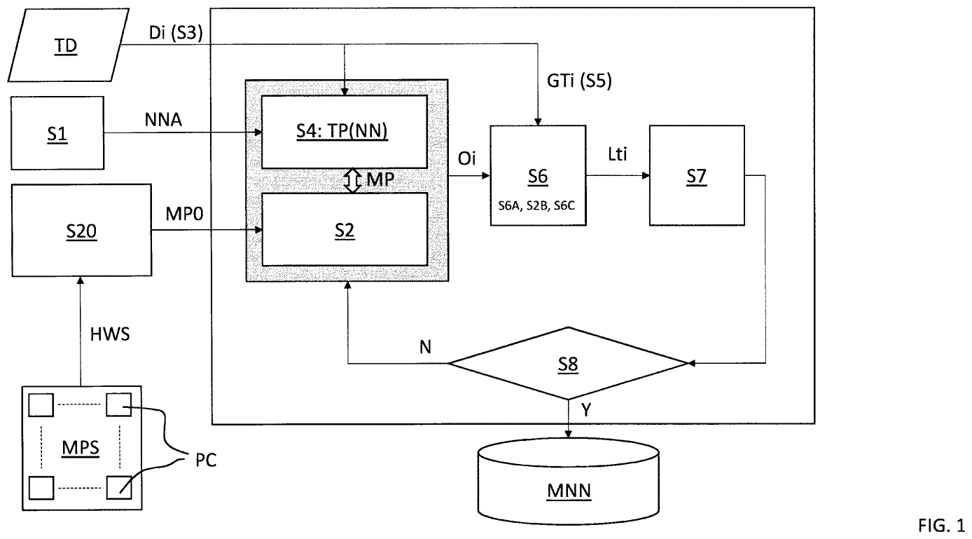

FIG. 1 schematically shows a first embodiment of a method for computation performance aware training of a neural network NN that is to be executed by a multicore processor system MPS, i.e. a processor system comprising a plurality of processor cores PC, to perform a data processing task.

Therein reference number S1 represents a process wherein a neural network architecture NNA of the neural network is provided. The neural network architecture NNA specifies the components of the network, e.g. convolutional layers, pooling layers and their interrelationship. The network architecture can be one known as such, e.g. a version of ResNet, of MobileNet or VGG or otherwise. The network as specified in process S1 still needs to be trained with training data in order to determine the network parameters with which it can perform the data processing task. Also an appropriate mapping of the trained neural network on the multi-core processor system MPS has to be found.

In process S3 and S5 training data TD {D1, GT1; D2, GT2; . . . . D2n, GTn} is provided comprising a plurality of pairs of input data Di and corresponding ground truth output data GTi. The training data TD for example comprises image data and ground truth data specifying object classes and their locations in the image data.

In the training procedure a sequence with the following processes is repeated.

In process S2 a tentative mapping MP of the neural network NN on the multicore processor system MPS is provided. A mapping specifies which parts of the multicore processor are to be allocated to which parts of the neural network.

The mapping for example allocates a respective set of one or more cores to each neural network layer of the neural network. The multicore processor MPS may comprise a communication network, e.g. a communication network on chip (NoC) with which the processor cores are enabled to communicate with each other. In one example the network capacity is allocated to the processor cores in a predetermined manner. In another example the allocation of the network capacity can be part of the mapping.

A mapping component performing the mapping process can be initialized in advance by an initialization procedure S20, wherein an initial mapping MPO is provided based on a specification HWS of the targeted hardware MPS. The tentative mapping serves to enable estimation of computation performance parameters, such as a latency occurring in the neural network NN, a throughput of the neural network, and a power consumption of the neural network, as if it were actually implemented on that target hardware according to the tentative mapping.

In process S4 the training processor TP executes the neural network NN in its current state of training to generate output data Oi in response to the input data Di provided in process S3. In this case the training processor TP executing the neural network NN is denoted as TP (NN). In this connection it is noted that in this procedure it is not necessary that the neural network NN is actually executed by the multi-core processor MPS for which it is trained to be used. It could be executed by any type of processor that can perform the training process in a reasonable amount of time.

In process S6 an aggregate loss Lti is computed. The computed aggregate loss is indicative for the progress of training the neural network NN for the purpose of performing the data processing task when executed by the targeted multicore processor MPS in accordance with the current mapping. The aggregate loss is computed in subprocesses S6A, S6B and S6C of process S6 as follows.

In subprocess S6A a task loss is computed that is a function of the output data Oi generated in process S4 and the ground truth output data GTi provided in process S5, in that it is an indication of a deviation between the generated output data Oi and the ground truth output data GTi. The task loss may include one or more of a regression loss and a class loss.

In subprocess S6B a computation performance loss is computed that is indicative for an estimation of the cost of executing the neural network in case it were mapped on the targeted multi-core processor MPS. In an example the computation performance loss indicates the estimation of a total latency expected to occur in the multi-core processor MPS, i.e. a length of a time-interval between receipt of the input data and providing the output data by the neural network when executed by the multi-core processor MPS according to the mapping.

In subprocess S6C the aggregate loss is computed from the task loss and the computation performance loss.

In process S7 weights of the neural network NN are updated by backpropagation of the aggregate loss.

In process S8 it is decided whether the neural network NN when mapped according to the current mapping MP onto the targeted hardware MPS meets performance requirements. In one example the performance requirements are met if the aggregate loss does not exceed a predetermined maximum. In another example the performance requirements are met if the task loss and the computation performance loss each do not exceed a respective predetermined maximum. In an alternative embodiment it is presumed that performance requirements are met if the training sequence is applied a predetermined number of times.

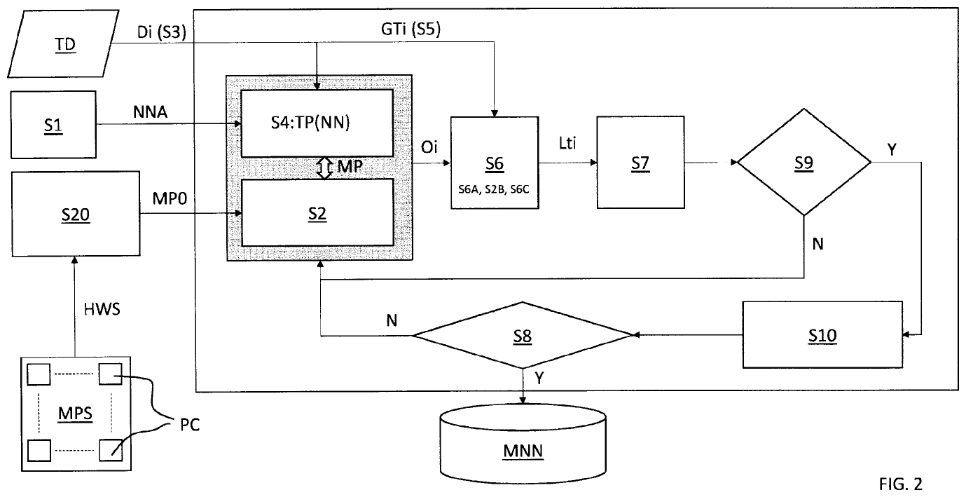

FIG. 2 shows a second embodiment of the method that differs from the method shown in FIG. 1, in that further a neural network optimization process S10 is applied. In the example shown the neural network optimization process S10 is applied each time it is determined in block S9 that the training sequence has been performed a predetermined number of times. The process of training and optimizing continues until it is decided in process S8 that the performance requirements are met.

In one example the neural network is optimized in process S10 by pruning. As a result of pruning the number of non-zero parameters of the neural network decreases, which tends to contribute to a more efficient execution with shorter latencies. An exemplary pruning approach is specified by Hao Li et al. in PRUNING FILTERS FOR EFFICIENT CONVNETS, which is published as a conference paper at ICLR 2017, and available as arXiv: 1608.08710v3 [cs.CV] 10 Mar. 2017.

In another example the neural network is optimized in process S10 by weight quantization. A reduction of the number of quantization levels may render possible a more efficient execution on the targeted hardware. In one example the weights of the network, or even the data being processed is quantized as a binary variable. This approach is discussed by Rastegari et al. in XNOR-Net: ImageNet Classification Using Binary Convolutional Neural Networks, available as arXiv: 1603.05279v4 [cs.CV] 2 Aug. 2016.

Optimization of the neural network, for example by pruning and/or quantization may also may result in a decrease of accuracy. The loss of accuracy is mitigated by subsequent execution of further training sequences.

Another optional optimization process that may be combined with pruning and/or quantization in a spiking neural network is sparsity control. In a spiking neural network a neural element issues an output message if an activation threshold is exceeded. In a sparsity control process the activation threshold is increased, so that the number of output messages is decreased. Consequently a computational load of recipient neural elements is also decreased. Furthermore message network load is decreased. These effects all contribute to a more efficient execution with shorter latencies. Also for this type of optimization a potential loss of accuracy is mitigated by subsequent execution of further training sequences.

Sparsity control is discussed by Kurtz et al. in Inducing and Exploiting Activation Sparsity for Fast Neural Network Inference. See Proceedings of the 37th International Conference on Machine Learning, Vienna, Austria, PMLR 119, 2020.

In this connection reference is further made to “ARTS: an adaptive regularization training schedule for activation sparsity exploration”, by Zeqi Zhu et al., see https://pure.tue.nl/ws/portalfiles/portal/215820255/ARTS_DSD_2022_Camera_Re ady.pdf

The authors propose therein a training schedule that provides for a joint weight and activation sparsification in a model by adaptively altering the regularization coefficient through training. The present invention provides for a further improvement in that the mapping information is employed to specifically optimize the use of activation sparsity for the neural network as mapped on the target hardware.

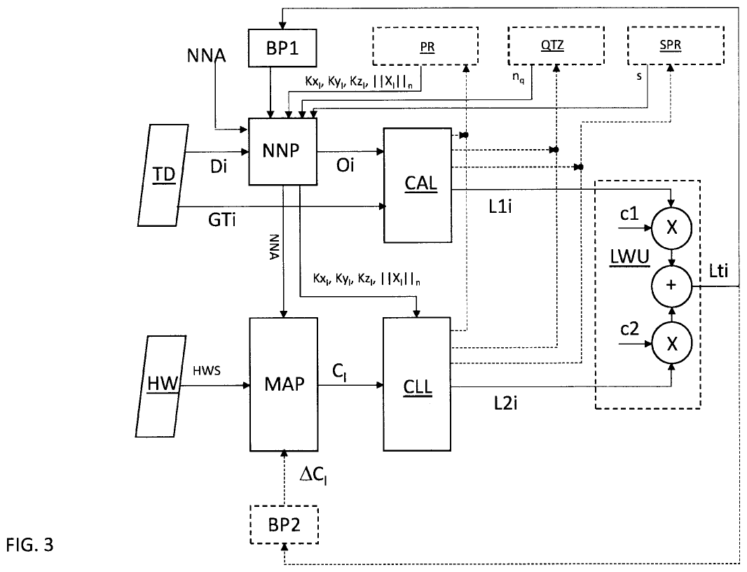

FIG. 3 schematically shows a first embodiment of an improved training system. Features therein corresponding to those present FIGS. 1 and 2 have a same reference, unless otherwise specified.

The improved training system is configured for training a neural network NN that is to be executed by a multicore processor system MPS comprising a plurality of processor cores PC to perform a data processing task,

As shown in FIG. 3, the training system is configured to receive a specification of a neural network architecture NNA for the neural network. It is further configured to receive training data TD comprising input data Di and ground truth output data GTi for determining neural network parameter values by training the neural network.

The training system comprises a mapping unit MAP and is therewith configured to provide a mapping of the neural network NN for the multicore processor system MPS. In an example, the mapping data Cl specifies how the cores of the processor are allocated to components (e.g. neural network layers) of the neural network NN.

The training system also has processing capacity to execute the neural network for training. In the example shown, the processing capacity is indicated as a general neural network processor NNP that is configured to execute the neural network as specified by the neural network architecture NNA so that it can be trained by repeating a training sequence. As noted, the hardware used by the training system typically is not the same as the hardware used for training, as the trained neural network may be applied by a large number of end users, each having their proper hardware, e.g. a mobile phone or a laptop.

As shown in FIG. 3, the training system comprises a task loss computation unit CAL, a computation performance loss computation unit CLL, an aggregate loss computation unit LWU and a backpropagation unit BP1. In this connection it is noted that these units may be provided in the system as respective dedicated hardware units, but that various other implementations are possible, e.g. the units may be software modules that are executed by a common data processing facility.

As noted, the neural network with the neural network architecture NNA will be executed, so that it can be trained by repeating a training sequence. The training sequence is described now in more detail.

The general neural network processor NNP or other processing facility of the training system executes the neural network NN being trained while providing a sample Di of the input data to the input of the neural network. As a result of the execution the neural network NN generates output data Oi in response to the sample of the input data Di.

The task loss computation unit CAL computes a task loss L1i that is indicative for a deviation between the generated output data Oi and the ground truth output data GTi corresponding to that sample of the input data Di. For example task loss computation unit CAL computes a classification loss indicative for an amount of misclassifications and/or a regression loss indicative for an extent to which a position estimation deviates from a position indicated by the ground truth output data GTi.

The computation performance loss computation unit CLL computes a computation performance loss L2i that is indicative for a cost of executing the neural network as if it were executed by the multi-core processor system MPS in accordance with the mapping provided by the mapping unit MAP.

In an embodiment the computation performance loss computation component CLL computes the computation performance loss as follows.

$${L}_{2 i} = {\sum }_{l} \frac{{Kx}_{l} \cdot {Ky}_{l} \cdot {Kz}_{l} \cdot {‖ {X}_{l} ‖}_{n}}{{C}_{l}}$$

Therein Kxₗ, Kyₗ, Kzₗ are the kernel sizes in x, y, and z dimensions, respectively for layer l, and Cₗ is the number of cores allocated to layer l as indicated by the mapper MAP. Furthermore, therein ∥Xₗ∥ₙ is the Ln norm of the layer, which is an indication of the number of non-zero elements in the layer and which is defined by

$${‖ {X}_{l} ‖}_{n} = \sqrt[n]{\sum {\vert x \vert}^{n}}$$

Subsequently, the aggregate loss computation unit LWU computes an aggregate loss Lti that is positively correlated with both the task loss L1i and the computation performance loss L2i. In the example shown the aggregate loss Lti is computed as a weighted sum of the task loss L1i and the computation performance loss L2i, I.e.

$$Lti = c 1 * L 1 i + c 2 * L 2 i$$

However other implementation of the loss weighting unit LWU are also possible, provided that the operation it performs is differentiable. In another example the aggregated loss is computed as

$$Lti = ( L 1 i + a 1 ) * ( L 2 i + a 2 )$$

Therewith the aggregate loss allows for a gradient descent training wherein the weights of individual layers are adjusted through backpropagation towards a minimum loss.

Based on the aggregated loss Lti, the first back propagation component BP1 applies a backpropagation operation to the neural network being trained, so as to update its weights. Due to the fact that the aggregated loss is partly determined by the latency loss, the backpropagation not only results in an adaptation of the network parameters that contribute to an improved accuracy but also results in a reduction of latency that is expected for the neural network being trained when mapped on the target hardware.

As shown in FIG. 3, as a first option, a mapping control component BP2 is provided that is configured to control the mapper MAP with a control signal ΔCl so as to update the mapping, taking into account the aggregated loss Lti.

Other optional components are a pruning component PR, a quantization control component QTZ and a sparsity control component SPR.

The optional pruning component PR is configured to apply a pruning operation to the current set of neural network parameters. Therewith it decreases the number of non-zero parameters as indicated for each neural network layer by the Ln norm ∥Xₗ∥ₙ of the layers. Also pruning may be applied by shrinking one or more kernel sizes Kxₗ, Kyₗ, Kzₗ. The pruning operation affects both the task loss L1i and the computation performance loss L2i. Generally pruning will contribute to a reduction in latency, i.e. reduced computation performance loss but also tend to increase the task loss, i.e. by reducing the accuracy. The relationships between the pruning operations and the effect thereof on the task loss L1i and the computation performance loss L2i cannot be expressed as a differentiable function. Accordingly the pruning operation is typically not applied in a gradient descent process but is performed with a different training process like evolutionary training, reinforcement learning, Bayesian optimization, etc.

The optional quantization control component QTZ determines the number of quantization levels nq with which neural network computations of a layer are to be performed in the target processor MPS. Typically the number of quantization levels is expressed as a power of 2. Also a change in the number of quantization levels by the quantization control component QTZ affects both the task loss L1i and the computation performance loss L2i. Generally a reduction of the number of quantization levels will contribute to a reduction of the computation performance loss for example by a reduction of the latency or by increasing the throughput or reducing a required supply power. In an extreme case the number of quantization levels is reduced to 2. In that case the neural network operations of a layer are simplified as Boolean operations which require only a minimum computation time. On the other hand a reduction of the number of quantization levels also tends to reduce the accuracy, i.e. to increase the task loss. Also the relationship between the quantization control operations and the effect thereof on the task loss L1i and the computation performance loss L2i cannot be expressed as a differentiable function. Accordingly also the quantization control operation is typically not applied in a gradient descent process but is performed with a different training process like evolutionary training, reinforcement learning, Bayesian optimization, etc.

The optional sparsity control component SPR determines with the parameter s a run-time behavior of the neural network NN. The parameter determines a sparsity with which neural network elements provide output data to their recipients. This can be the case in that the parameter s defines an activation threshold that the state value of a neural element needs to exceed in order to issue a spike to its recipient neural network elements. A higher activation threshold results in an increased sparsity. Generally, an increased sparsity will result in a decreased latency as recipient neural network elements receive a lower number of input data and need to perform a lower number of operations per unit time. Also a reduced network load as a result of the increased sparsity can contribute to a reduction in latency, a reduction of computation power and/or in an increased throughput. I.e. an increased sparsity generally results in a reduction of the computation performance loss. However, additionally an the increased sparsity tends to increase the task loss.

Also the relationships between the sparsity control operations and the effect thereof on the task loss L1i and the computation performance loss L2i cannot be expressed as a differentiable function. Accordingly also the sparsity control operation is typically not applied in a gradient descent process but is performed with a different training process like evolutionary training, reinforcement learning, Bayesian optimization, etc.

Each of the components BP2, PR, QTZ and SPR or combination thereof can be optionally included in order to contribute to a reduction of the aggregate losses.

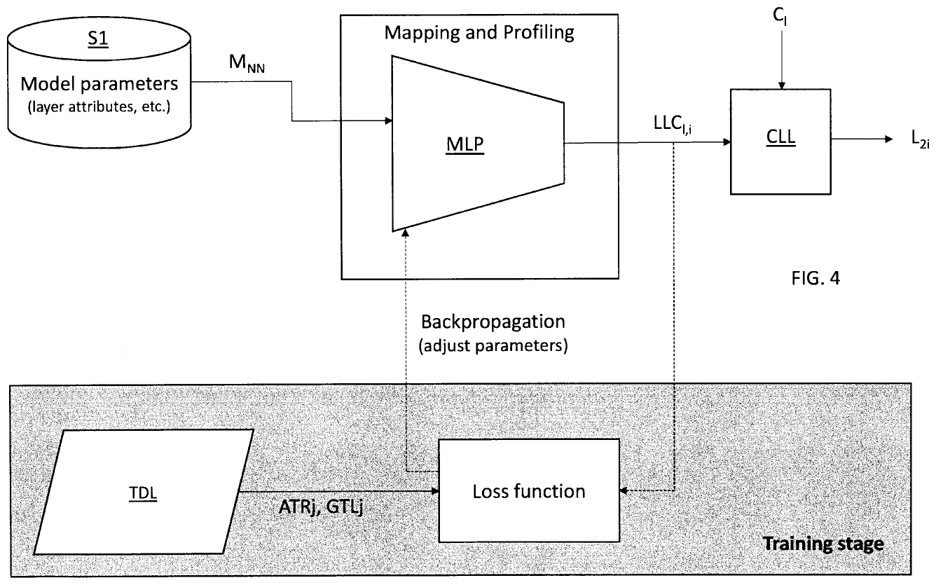

FIG. 4 shows a detail of a further embodiment of the training system, wherein a multi-layer perceptron MLP is included that is configured to predict the latency per layer per core. Herein, the input to the multi-layer perceptron is a matrix MNN having at one axis an identification of neural network elements and on the other axis their features such as Ln-norm, kernel size, etc. As shown in the lower part of FIG. 4 in this approach the multi-layer perceptron MLP is trained in advance with training data TDL, that comprises a plurality of training examples. Each training example ATRj specifies a set of values for attributes with which a layer can be configured, e.g. its kernel size, its number of inputs its stride and an associated ground truth GTLj that indicates the expected latency in case that layer were executed by a single processor core.

Therefore, during the inference, when training the neural network NN, the multi-layer perceptron MLP does not need to have explicit information of the mapping, but, given the neural network elements and other features such as Ln-norm and kernel size it can approximate the load per element (e.g. layer) per core LLC_{1,i} involved in processing training data Di. The computation performance loss computation component CLL computes the computation performance loss L2i as follows.

$${L}_{2 i} = {\sum }_{l} \frac{{LLC}_{l , i}}{{C}_{l}}$$

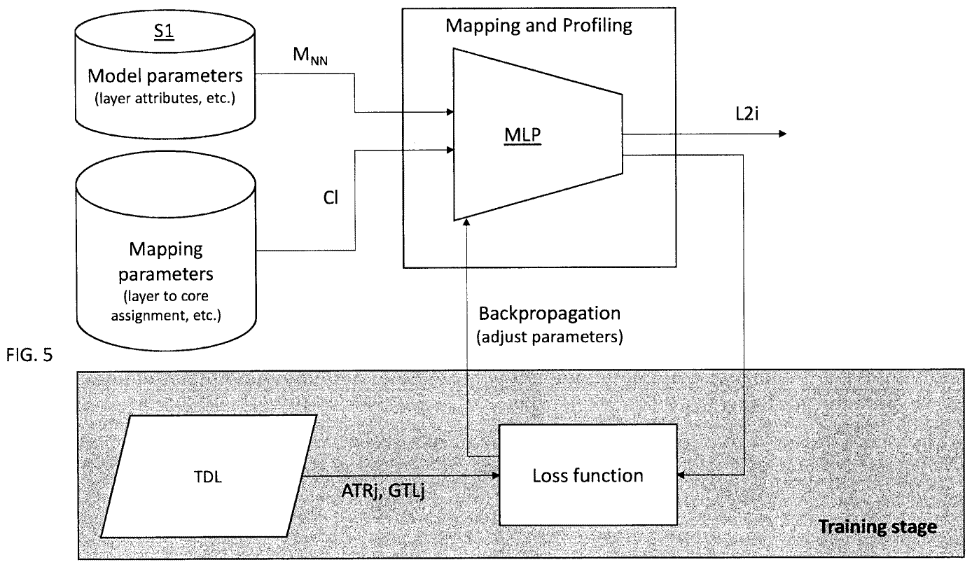

FIG. 5 shows another example. In this case also a specification Cl of a current mapping of the neural network NN on the targeted hardware HW is provided at the input of the multi-layer perceptron. Accordingly, herein, the input to the multi-layer perceptron is a matrix M_{NN} having at one axis an identification of neural network elements and on the other axis their features such as Ln-norm, kernel size, etc. In this example, the number of cores assigned to each network layer is also included as a feature. With these input data the multi-layer perceptron MLP is configured to predicts the total latency of the neural network in its current state of training when it were mapped to the targeted hardware MPS. This embodiment requires that the mapping is re-evaluated after n training steps, to ensure its validity for the updated weights and network structure.

As will be apparent to a person skilled in the art, the elements listed in the system claims are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. For example in the embodiment of the training system discussed with reference to FIG. 3, several functions are shown as discrete blocks for clarity of the drawing. These comprise the general neural network processor NNP, the task loss computation unit CAL, the computation performance loss computation unit CLL, the aggregate loss computation unit LWU, the mapping unit MAP etc. Two or more of these functional blocks may be implemented as software modules to be performed by a general purpose processor. Also it is possible that a single functional block, for example the general neural network processor NNP, is implemented as a multi-core processor. The invention can be implemented by means of hardware comprising several distinct elements, and by means of a suitably programmed computer. In the apparatus claim enumerating several means, several of these means can be embodied by one and the same item of hardware

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1-14. (canceled)

15. A method for training a neural network to be executed by a multi-core processor system comprising a plurality of processor cores, the method comprising;
accessing a mapping of the neural network to the multi-core processor system; and
training the neural network by executing a training procedure comprising:
executing the neural network to generate output data in response to input data;
computing a task loss indicative of deviation between the output data and ground truth output data;
computing a computation performance loss indicative of a cost of executing the neural network as if it were executed by the multi-core processor system in accordance with the mapping;
computing an aggregate loss that is at least partially positively correlated with both the task loss and the computation performance loss; and
updating weights of the neural network by backpropagation based on the aggregate loss.

16. The method of claim 15, wherein the training comprises executing the training procedure multiple times, the method further comprising:
performing remapping to obtain an updated mapping each time after the training procedure has been executed a predetermined number of times; and
executing the training procedure at least once in accordance with each updated mapping.

17. The method of claim 15, wherein the training comprises executing the training procedure multiple times, the method further comprising:
pruning the neural network each time after the training procedure has been executed a predetermined number of times.

18. The method of claim 15, wherein the training comprises executing the training procedure multiple times, the method further comprising:
adjusting quantization levels of neural network computations each time after the training procedure has been executed a predetermined number of times.

19. The method of claim 15, wherein the training comprises executing the training procedure multiple times, the method further comprising:
adjusting an activation sparsity associated with the neural network each time after the training procedure has been executed a predetermined number of times.

20. The method of claim 15, wherein computing the computation performance loss comprises computing a computation performance indicator associated with at least one of latency, throughput, or power consumption.

21. The method of claim 15, wherein computing the computation performance loss comprises computing multiple computation performance indicators associated with at least one of latency, throughput, or power consumption.

22. The method of claim 15, wherein computing the computation performance loss comprises executing at least one multi-layer perceptron.

23. The method of claim 22, wherein the at least one multi-layer perceptron takes, as input, a matrix that identifies layers of the neural network and one or more features of the layers.

24. The method of claim 23, wherein the one or more features comprise at least one of Lₙ-norm or kernel size.

25. The method of claim 23, wherein the one or more features comprise core allocations.

26. The method of claim 22, wherein the at least one multi-layer perceptron generates estimates for single-core layer latency, the method further comprising:
estimating latency per layer by dividing the single-core layer latency by a number of cores of the plurality of processor cores assigned to each layer of the neural network; and
estimating total latency by accumulating the latency estimated for each layer.

27. The method of claim 15, wherein computing the aggregate loss comprises computing a weighted sum of the task loss and the computation performance loss.

28. The method of claim 15, wherein the mapping comprises an allocation of cores of the plurality of processor cores to layers of the neural network.

29. The method of claim 15, wherein the training is performed by a training processor system that differs from the multi-core processor system.

30. A system comprising:
at least one memory that stores instructions; and
one or more processors configured by the instructions to perform operations comprising:
accessing a mapping of a neural network to a multi-core processor system comprising a plurality of processor cores; and
training the neural network by executing a training procedure comprising:
executing the neural network to generate output data in response to input data;
computing a task loss indicative of deviation between the output data and ground truth output data;
computing a computation performance loss indicative of a cost of executing the neural network as if it were executed by the multi-core processor system in accordance with the mapping;
computing an aggregate loss that is at least partially positively correlated with both the task loss and the computation performance loss; and
updating weights of the neural network by backpropagation based on the aggregate loss.

31. The system of claim 30, wherein the training comprises executing the training procedure multiple times, the operations further comprising:
performing remapping to obtain an updated mapping each time after the training procedure has been executed a predetermined number of times; and
executing the training procedure at least once in accordance with each updated mapping.

32. The system of claim 30, wherein computing the computation performance loss comprises executing at least one multi-layer perceptron.

33. The system of claim 32, wherein the at least one multi-layer perceptron takes, as input, a matrix that identifies layers of the neural network and one or more features of the layers.

34. One or more non-transitory computer-readable media storing computer-executable instructions that, when executed by a computing system, cause the computing system to perform operations comprising:
accessing a mapping of a neural network to a multi-core processor system comprising a plurality of processor cores; and
training the neural network by executing a training procedure comprising:
executing the neural network to generate output data in response to input data;
computing a task loss indicative of deviation between the output data and ground truth output data;
computing a computation performance loss indicative of a cost of executing the neural network as if it were executed by the multi-core processor system in accordance with the mapping;
computing an aggregate loss that is at least partially positively correlated with both the task loss and the computation performance loss; and
updating weights of the neural network by backpropagation based on the aggregate loss.
